(19) United States
(12) Patent Application Publication
(10) Pub. No.: US 2025/0156983 A1
(43) Pub. Date: May 15, 2025

(54) RECOMMENDATION SYSTEM

(71) Applicant: NTT DOCOMO, INC., Tokyo (JP)

(72) Inventors: Takuya IZUMISAWA, Chiyoda-ku (JP); Akira YAMADA, Chiyoda-ku (JP); Takashi SUZUKI, Chiyoda-ku (JP)

(73) Assignee: NTT DOCOMO, INC., Tokyo (JP)

(21) Appl. No.: 18/839,116

(22) PCT Filed: Feb. 22, 2023
(86) PCT No.: PCT/JP2023/006492

§ 371 Date: Aug. 16, 2024

(30) Foreign Application Priority Data
Apr. 11, 2022 (JP) 2022-064958

(51) Int. Cl. G06Q 50/40

(52) U.S. Cl. CPC G06Q 50/40

(57) ABSTRACT

A recommendation system includes an acquisition unit configured to acquire movement information indicating a departure point and a destination related to a future movement of a user using a means of transportation emitting CO2, an emission amount estimation unit configured to estimate, for a movement related to the movement information acquired by the acquisition unit, a CO2 emission amount due to the movement for each of a plurality of movement timings different from each other, and a determination unit configured to determine a facility that the user can visit during the movement and that is recommended to the user, on the basis of the CO2 emission amount for each movement timing, estimated by the emission amount estimation unit.

### TECHNICAL FIELD

The present invention relates to a recommendation system.

### BACKGROUND ART

In the related art, it is proposed to search for a route in which a carbon dioxide (CO2) emission amount emitted from a vehicle is minimized when moving from a departure point to a destination by the vehicle (for example, refer to Patent Literature 1).

### CITATION LIST

### Patent Literature

Patent Literature 1: Japanese Unexamined Patent Publication No. 2009-79995

### SUMMARY OF INVENTION

### Technical Problem

However, as described in Patent Literature 1, the CO2 emission amount may not be necessarily reduced by simply searching for the route in which the CO₂ emission amount emitted from the vehicle is minimized.

One embodiment of the present invention has been made in consideration of the circumstance described above, and an object thereof is to provide a recommendation system capable of reducing a CO2 emission amount.

### Solution to Problem

In order to attain the object described above, a recommendation system according to one embodiment of the present invention includes an acquisition unit configured to acquire movement information indicating a departure point and a destination related to a future movement of a user using a means of transportation emitting CO2, an emission amount estimation unit configured to estimate, for a movement related to the movement information acquired by the acquisition unit, a CO2 emission amount due to the movement for each of a plurality of movement timings different from each other, and a determination unit configured to determine a facility that the user can visit during the movement and that is recommended to the user, on the basis of the CO2 emission amount for each movement timing, estimated by the emission amount estimation unit.

In the recommendation system according to one embodiment of the present invention, the CO2 emission amount due to the movement for each of the plurality of movement timings is estimated, and the facility that the user can visit during the movement and that is recommended to the user is determined on the basis of the estimated CO2 emission amount. By the user visiting the facility during the movement in accordance with such a recommendation, it is possible to have the movement timing of the user coincide with a timing when the CO2 emission amount is low. Therefore, according to the recommendation system according to one embodiment of the present invention, it is possible to reduce the CO2 emission amount.

### Advantageous Effects of Invention

According to one embodiment of the present invention, it is possible to reduce the CO2 emission amount.

### BRIEF DESCRIPTION OF DRAWINGS

FIG. 1 is a diagram illustrating a configuration of a recommendation system according to an embodiment of the present invention.

FIG. 2 is a drawing for illustrating an outline of a recommendation of the recommendation system.

FIG. 3 is a table illustrating an example of information related to a user used in the recommendation system.

FIG. 4 is a table illustrating an example of road traffic information used in the recommendation system.

FIG. 5 is a graph illustrating an example of a correspondence relationship between a traveling speed of an automobile and a CO2 emission amount, used in the recommendation system.

FIG. 6 is a table illustrating an example of a CO2 emission amount for each movement timing, estimated in the recommendation system.

FIG. 7 is a table illustrating an example of information related to a facility used in the recommendation system.

FIG. 8 is a table illustrating an example of information indicating a facility determined to be recommended to the user, in the recommendation system.

FIG. 9 is a flowchart illustrating processing executed by the recommendation system according to the embodiment of the present invention.

FIG. 10 is a diagram illustrating a hardware configuration of the recommendation system according to the embodiment of the present invention.

### DESCRIPTION OF EMBODIMENTS

Hereinafter, an embodiment of a recommendation system according to the present invention will be described in detail together with the drawings. Note that, in the description of the drawings, the same reference numerals will be applied to the same elements, and the repeated description will be omitted.

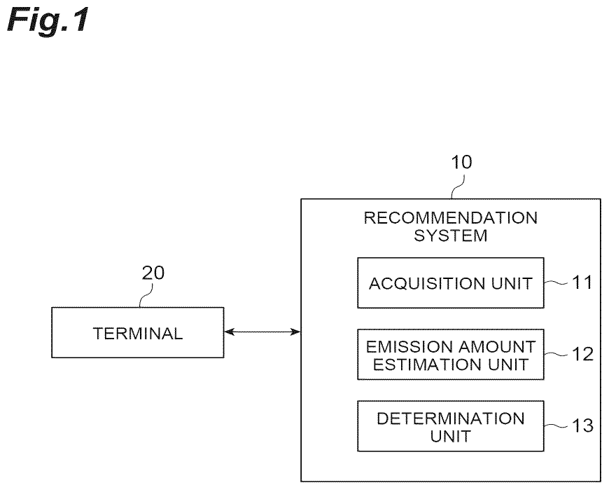

FIG. 1 illustrates a recommendation system 10 according to this embodiment. The recommendation system 10 is a system (a device) recommending a facility that a user can visit during a movement. In this embodiment, the movement of the user, for example, is a movement when the user returns home from a place where the user goes out using an automobile such as a private automobile. The recommendation of the recommendation system 10 is to reduce a CO2 emission amount due to the use of the automobile. Note that, the movement of the user may be a movement using a means of transportation emitting CO2, other than the automobile. In addition, the movement of the user may be a movement other than the movement when returning home.

The recommendation system 10, for example, performs the recommendation by transmitting information related to the recommendation to a terminal 20 used by the user. The terminal 20 is a device that is capable of performing the transmission and reception of information with respect to the recommendation system 10 via a network such as a mobile communication network and is capable of performing information processing related to the recommendation. The terminal 20 is a device such as a mobile phone, a smart phone, or a personal computer (PC). A part of the information used in the recommendation system 10 may be acquired by the terminal 20 and transmitted to the recommendation system 10.

The recommendation system 10 is composed of a computer having a communication function, such as PC or a server device. The recommendation system 10 may be composed of a plurality of computers. The recommendation system 10 is capable of performing the transmission and reception of the information with respect to the terminal 20 via a network such as a mobile communication network.

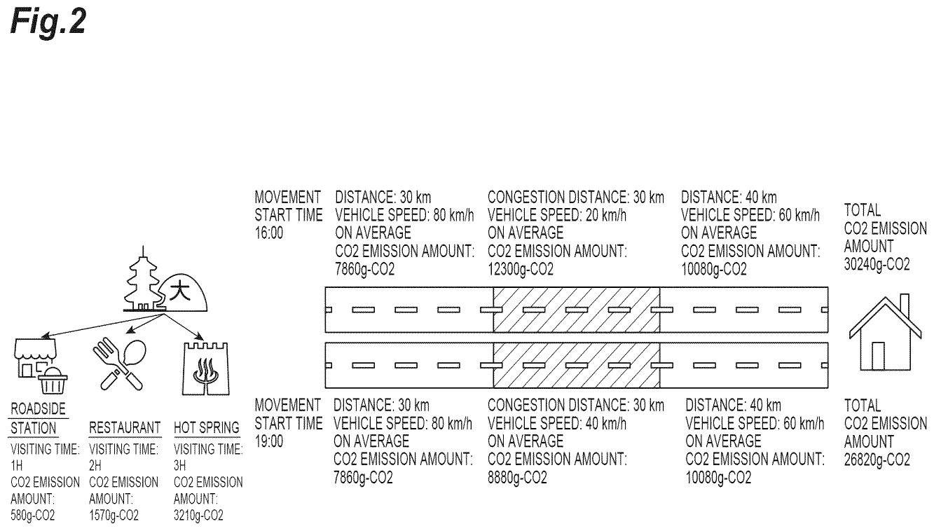

FIG. 2 illustrates the outline of the recommendation of the recommendation system 10 according to this embodiment. The CO2 emission amount due to the use of the automobile is different in accordance with the traveling speed of the automobile. The CO2 emission amount increases as the traveling speed decreases. As illustrated in FIG. 2, the traveling speed of the automobile depends on the condition of a road on which the automobile travels. In addition, the condition of the road is different in accordance with time. Accordingly, the CO2 emission amount due to the use of the automobile depends on the movement timing of the user.

For example, as illustrated in FIG. 2, the average vehicle speed in the section of the road is different between a case where a movement start time (a departure time) is 16:00 and a case where the movement start time is 19:00. In a case where the movement start time is 19:00, the traveling speed is higher and the CO2 emission amount is lower than a case where the movement start time is 16:00. Accordingly, by delaying the movement start time from 16:00 to 19:00, it is possible to reduce the CO2 emission amount.

The recommendation system 10 acquires the CO2 emission amount that can be reduced by delaying the movement start time as described above, as a credit, and recommends a peripheral facility that can be visited within the range of the credit. By the user visiting the recommended facility, it is possible to have the movement timing of the user coincide with a timing when the CO2 emission amount can be reduced. That is, the recommendation system 10 recommends a detour using the credit of CO2 emission.

Subsequently, the function of the recommendation system 10 according to this embodiment will be described. As illustrated in FIG. 1, the recommendation system 10 is configured by including an acquisition unit 11, an emission amount estimation unit 12, and a determination unit 13.

The acquisition unit 11 is a function unit configured to acquire movement information indicating a departure point and a destination related to a future movement of the user using a means of transportation emitting CO2. For example, the acquisition unit 11 acquires the movement information as follows.

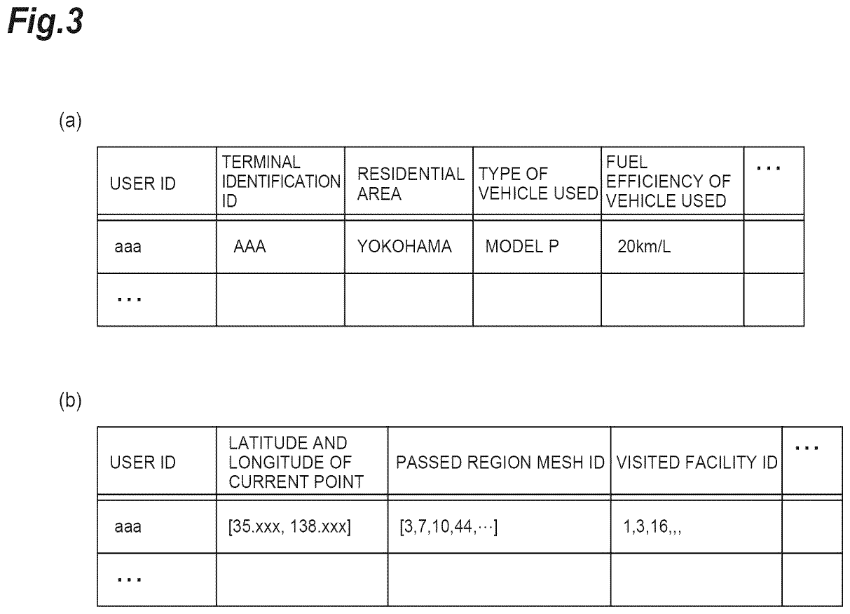

The recommendation system 10 includes a database storing in advance user information related to the user to be a recommendation target. FIG. 3(a) illustrates the user information stored in the recommendation system 10. In the user information, a user ID, a terminal identification ID, a residential area, the type of vehicle used, and the fuel efficiency of the vehicle used are associated with each other. The user ID is an identifier set in advance for the user to be the recommendation target. The terminal identification ID is an identifier set in advance for the terminal 20 used by the user to be the recommendation target. When the transmission and reception of the information is performed between the recommendation system 10 and the terminal 20, the user ID or the terminal identification ID is used such that the recommendation system 10 is capable of grasping with which user or terminal 20 the information is exchanged.

The residential area is information indicating an area where the user lives. As described below, on the basis of the residential area, the destination of the movement of the user is specified. Accordingly, the residential area may be information capable of specifying the destination of the movement. The type of vehicle used is information indicating the type of automobile used by the user for the movement. The fuel efficiency of the vehicle used is information indicating the fuel efficiency of the automobile. Each piece of information of the type of vehicle used and the fuel efficiency of the vehicle used is information used for the estimation of the CO2 emission amount described below. Note that, the fuel efficiency of the vehicle used may be information according to the traveling speed (for example, the average speed) of the automobile. In addition, the fuel efficiency of the vehicle used may be estimated on the basis of a relationship (for example, information published by a public institution or a producer of the automobile) between the average speed per hour and a fuel index, and the like, stored in advance. In addition, the information used for the estimation of the CO2 emission amount may include information other than the information described above. For example, the information used for the estimation of the CO2 emission amount may include information indicating the past travel distance (the total travel distance) of the automobile used by the user for the movement, and the like.

Each piece of information of the residential area, the type of vehicle used, and the fuel efficiency of the vehicle used, for example, is registered in advance in the recommendation system 10 by the user, as profile registration. In addition, the residential area may be estimated from position information indicating the position of the user to be the recommendation target. For example, an area where the user stays for a long time late at night may be the residential area.

The acquisition unit 11 acquires the position information indicating the position of the user to be the recommendation target. For example, the acquisition unit 11 periodically receives and acquires information indicating the latitude and the longitude indicating the current point of the user from the terminal 20 of the user. The latitude and the longitude indicating the current point of the user, for example, are acquired by a positioning means such as a global positioning system (GPS) of the terminal 20, and are transmitted to the recommendation system 10 from the terminal 20. The acquisition unit 11 stores the acquired position information in the database of the recommendation system 10. FIG. 3(b) illustrates information related to the position information stored in the recommendation system 10.

Such information is information in which the user ID, the latitude and the longitude of the current point, a passed region mesh ID, and a visited facility ID are associated with each other. The latitude and the longitude of the current point are the latest information indicating the latitude and the longitude indicating the current point of the user, received and acquired from the terminal 20 of the user. The passed region mesh ID is a region mesh ID of a region mesh that the user passed through during a predetermined period in the past (for example, a period since the user last left the residential area) backward from the current time point. The region mesh ID is an identifier set in advance for a mesh into which a region is divided. The acquisition unit 11 creates the passed region mesh ID from the latitude and the longitude of the current point, and the like, acquired in the past, and stores the passed region mesh ID in the database. As illustrated in FIG. 3(b), the passed region mesh ID may include a plurality of IDs.

The visited facility ID is a facility ID of a facility that the user visited during a predetermined period in the past (for example, a period since the user last left the residential area) backward from the current time point. The facility ID is an identifier set in advance for the facility. By the technology or the like of the related art, the acquisition unit 11 determines the facility that the user visited, creates the visited facility ID, and stores the visited facility ID in the database. As illustrated in FIG. 3(b), the visited facility ID may include a plurality of facility IDs.

The acquisition unit 11 may determine whether to set the user as the recommendation target, on the basis of the history of the acquired position information of the user. For example, the acquisition unit 11 performs the determination as follows. The acquisition unit 11 reads out the user information of the user as a determination target from the database of the recommendation system 10. The acquisition unit 11 determines whether to set the user as the recommendation target from the acquired position information and the residential area of the user information, using a criterion set in advance.

In the criterion described above, for example, in a case where the user is away from the residential area by a distance or more that is a threshold value set in advance, and stays in the same area for a period or longer, set in advance, the user is set as the recommendation target. That is, in the criterion described above, in a case where the user stays in the place where the user goes out, the user is set as the recommendation target. Note that, the same area described above may be a specific area set in advance, or may be defined by the size of an area regarded as the same area. In addition, the distance and the period described above are set in advance. In addition, the determination described above may be performed at a timing set in advance, or may be performed periodically.

In addition, the acquisition unit 11 may determine whether the user is moving by a private automobile from the history of the position information, and the like, and may set the user as the recommendation target in a case where it is determined that the user is moving by the private automobile. In addition, in a case where it is determined that the user goes out using a public transportation or the like instead of the private automobile, the acquisition unit 11 may not set the user as the recommendation target, and may not perform the subsequent processing. The determination of the means of transportation described above may be performed by the technology or the like of the related art.

The acquisition unit 11 acquires the information indicating the current point of the user who is the recommendation target, as information indicating the departure point related to the future movement of the user that is a part of the movement information. In addition, the acquisition unit 11 acquires the information indicating the residential area of the user, as information indicating the destination related to the future movement of the user that is a part of the movement information. The acquisition unit 11 outputs the acquired movement information to the emission amount estimation unit 12.

Note that, the user who is the recommendation target is not necessarily determined as described above, and may be determined by any method. For example, a user who has requested a recommendation may be set as the user who is the recommendation target. In addition, the movement information is not necessarily acquired as described above, and may be acquired by any method. For example, the information indicating the departure point and the destination may be received and acquired from the terminal 20.

The emission amount estimation unit 12 is a function unit configured to estimate, for a movement related to the movement information acquired by the acquisition unit 11, the CO2 emission amount due to the movement for each of a plurality of movement timings different from each other. The emission amount estimation unit 12 may estimate the CO2 emission amount from the movement speed for each movement timing. For example, the emission amount estimation unit 12 estimates the CO2 emission amount as follows.

The emission amount estimation unit 12 inputs the movement information from the acquisition unit 11. The emission amount estimation unit 12 estimates a movement route of the automobile from the departure point to the destination indicated by the movement information. The movement route may be estimated by the technology or the like of the related art. In addition, the emission amount estimation unit 12 may acquire the user information of the user who is the recommendation target, and may use the passed region mesh ID of the user information when estimating the movement route. For example, in a case where the region mesh indicated by the passed region mesh ID covers an expressway, a movement route using an expressway may be estimated. In addition, in a case where the region mesh indicated by the passed region mesh ID does not cover the expressway, a movement route using a general road (a local road) other than the expressway may be estimated.

The emission amount estimation unit 12 acquires, for the estimated movement route, the information indicating the traveling speed that is the movement speed for each movement timing. As described above, the emission amount estimation unit 12 estimates the CO2 emission amount due to the movement for each of the plurality of movement timings different from each other. For example, the emission amount estimation unit 12 estimates the CO2 emission amount in the case of departing from the departure point at the current time point and at regular intervals from the current time point. For example, when the current time point is 15:00, the CO2 emission amount in each case where the movement start time is 15:00, 16:00, 17:00, 18:00, 19:00, and the like is estimated. The emission amount estimation unit 12 acquires the information indicating the traveling speed in each case.

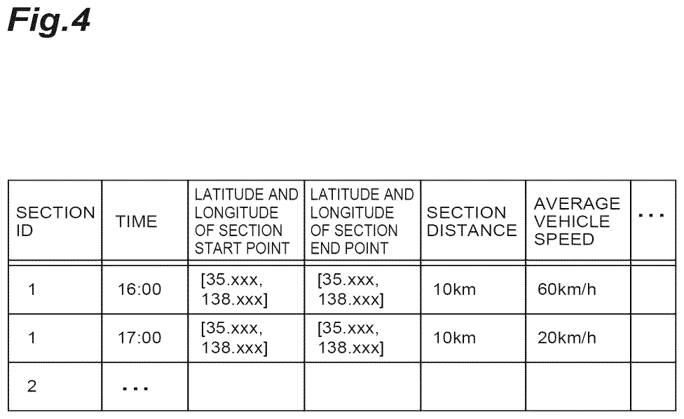

The emission amount estimation unit 12 acquires in advance information indicating a predictive value of the traveling speed (for example, the average vehicle speed) for each time and for each section of the road. For example, the emission amount estimation unit 12 acquires in advance road traffic information illustrated in FIG. 4. The road traffic information is information in which a section ID, time, the latitude and the longitude of a section start point, the latitude and the longitude of a section end point, a section distance, and the average vehicle speed are associated with each other. The section ID is an identifier set in advance for the section of the road. The time is information indicating a time corresponding to the average vehicle speed. The latitude and the longitude of the section start point and the latitude and the longitude of the section end point are information indicating the latitude and the longitude that are the position of the start point and the end point of the section of the road. The section distance is information indicating the distance of the section of the road. The average vehicle speed is information indicating the average vehicle speed in the section at the corresponding time.

The emission amount estimation unit 12 may acquire the road traffic information from an institution or the like managing the road, or may acquire the information indicating the traveling speed of the terminal of the vehicle traveling on the road, and may estimate and acquire the road traffic information from the information. Note that, the road traffic information may be regularly updated when traffic congestion occurs or the like.

The emission amount estimation unit 12 acquires, for the estimated movement route, the information indicating the traveling speed for each movement timing using the acquired road traffic information. As described above, in a case where the road traffic information is for each time and each section, information indicating the traveling speed for each time and each section according to the movement timing in the movement route may be acquired.

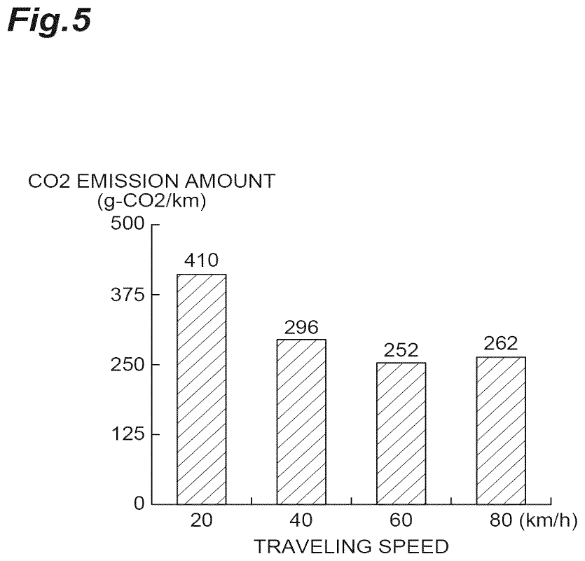

The emission amount estimation unit 12 estimates the CO2 emission amount from the traveling speed for each movement timing. The emission amount estimation unit 12, for example, stores in advance a correspondence relationship between the traveling speed of the automobile and the CO2 emission amount (for example, a CO2 emission amount per unit distance (g-CO2/km)), as illustrated in FIG. 5, and computes the CO2 emission amount using the correspondence relationship. The emission amount estimation unit 12 computes the CO2 emission amount per unit distance (g-CO2/km) from the traveling speed for each section in the movement route using the correspondence relationship described above, and multiplies the CO2 emission amount per unit distance by the distance of the section to compute the CO2 emission amount (g-CO2) of the section. The emission amount estimation unit 12 adds up the CO2 emission amount (g-CO2) for each section to compute (estimate) the CO2 emission amount (g-CO2) of the entire movement route.

The CO2 emission amount can be according to the type of automobile, the fuel efficiency of the automobile, the past travel distance of the automobile, and the like, in addition to the traveling speed. In consideration of the above, the emission amount estimation unit 12 may compute the CO2 emission amount of the movement route. For example, the emission amount estimation unit 12 computes the CO2 emission amount of the movement route as follows. The emission amount estimation unit 12 stores in advance parameters according to the type of automobile, the fuel efficiency of the automobile, and the past travel distance of the automobile. In addition, the emission amount estimation unit 12 acquires the information of the type of vehicle used, the fuel efficiency of the vehicle used, and the travel distance of the user who is the recommendation target, from the user information or the like illustrated in FIG. 3(a), and multiplies the CO2 emission amount by the parameters corresponding to such information to compute the CO2 emission amount of the movement route. Alternatively, the correspondence relationship between the traveling speed of the automobile and the CO2 emission amount, as illustrated in FIG. 5, may be stored for each type of automobile, each fuel efficiency of the automobile, and each past travel distance of the automobile, and the CO2 emission amount of the movement route may be computed using a correspondence relationship corresponding to the information of the type of vehicle used, the fuel efficiency of the vehicle used, and the travel distance of the user who is the recommendation target.

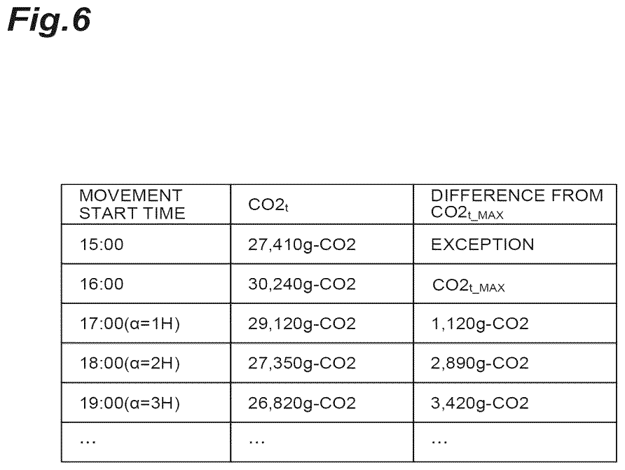

An example of the computed CO2 emission amount for each movement timing is illustrated in a table of FIG. 6. As illustrated in FIG. 6, a CO2 emission amount (CO2ₜ) is computed for each movement start time indicating the movement timing (CO2_{t_MAX} will be described below). The emission amount estimation unit 12 outputs information indicating the CO2 emission amount estimated for each movement timing to the determination unit 13.

The emission amount estimation unit 12 may estimate the CO2 emission amount due to the movement in a case where the user visits a facility to be a candidate recommended to the user during the movement. For example, the emission amount estimation unit 12 estimates the CO2 emission amount in the above case as follows.

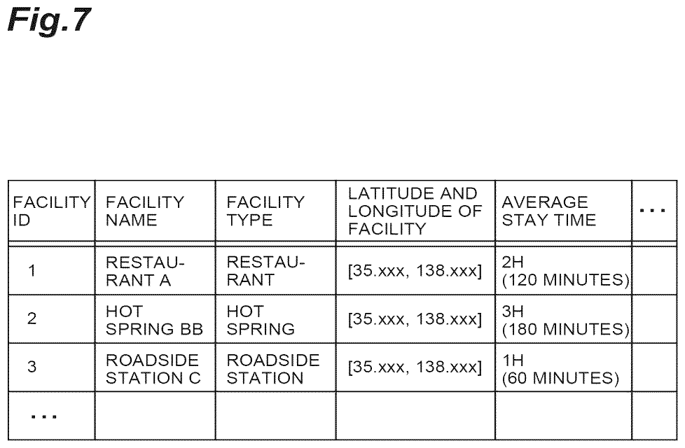

The recommendation system 10 includes a database storing in advance peripheral facility information related to the facility to be the candidate recommended to the user. FIG. 7 illustrates the peripheral facility information stored in the recommendation system 10. In the peripheral facility information, a facility ID, a facility name, a facility type, the latitude and the longitude of the facility, and the average stay time are associated with each other. The facility ID is an identifier set in advance for the facility to be the recommended candidate. The facility ID is the same as that used for the visited facility ID in FIG. 3(b). The facility name is information indicating the name of the facility. The facility type is information indicating the type of facility (for example, as illustrated in FIG. 7, types such as a restaurant, a hot spring, or a roadside station). The latitude and the longitude of the facility are information indicating the latitude and the longitude that are the position of the facility. The average stay time is information indicating the average length of time for which the user stays in the facility. The average length of the time for which the user stays in the facility is the assumed stay time in the facility. The peripheral facility information, for example, is registered in advance in the recommendation system 10 by an administrator (a system provider) of the recommendation system 10.

The emission amount estimation unit 12 determines the facility to be the candidate recommended to the user, with reference to the peripheral facility information. The purpose of recommending the facility to the user in this embodiment is to make the user delay the movement start time that is a departure timing from the departure point. Accordingly, the facility to be the candidate recommended to the user, for example, is a facility in the vicinity of the departure point of the user. Specifically, the emission amount estimation unit 12 determines the facility to be the candidate recommended to the user, on the basis of a distance between the departure point of the user and the position of the facility. For example, the emission amount estimation unit 12 determines a facility of which the distance described above is within a threshold value set in advance as the facility to be the candidate recommended to the user. In addition, the emission amount estimation unit 12 may exclude a facility indicated by the visited facility ID illustrated in FIG. 3(b) from the facility to be the candidate recommended to the user. Note that, the determination of the facility to be the recommended candidate is not necessarily performed, and all the stored facilities may be the facility to be recommended candidate.

The emission amount estimation unit 12 estimates the movement route in the case of visiting each facility to be the recommended candidate from the movement route. The emission amount estimation unit 12 estimates a movement time and a CO2 emission amount for the estimated movement route of visiting the facility. The estimation of the movement route and the CO2 emission amount related to visiting the facility may be performed as with the estimation related to the movement route described above. In addition, the estimation of the movement time for visiting the facility may be performed by the technology or the like of the related art. In addition, the estimation of the movement route and the CO2 emission amount related to visiting the facility may be also performed for each movement timing, as with the estimation related to the movement route described above. Here, in a case where the influence of the timing on the movement of visiting the facility is less than on the movement from the departure point to the destination, the estimation related to visiting the facility may not be performed for each movement timing.

The emission amount estimation unit 12 outputs the peripheral facility information related to the facility to be the recommended candidate, and information indicating the movement time and the CO2 emission amount in the case of visiting the facility to the determination unit 13.

The determination unit 13 is a function unit configured to determine the facility that the user can visit during the movement and that is recommended to the user, on the basis of the CO2 emission amount for each movement timing, estimated by the emission amount estimation unit 12. The determination unit 13 may compute a difference between the highest CO2 emission amount among the plurality of movement timings and a CO2 emission amount at the other timing, and may determine the facility on the basis of the computed difference. The determination unit 13 may determine the facility also on the basis of the CO2 emission amount due to the movement when the user visits the facility during the movement, estimated by the emission amount estimation unit 12. The determination unit 13 may determine the facility also on the basis of the assumed stay time in the facility to be the candidate recommended to the user. For example, the determination unit 13 determines the facility recommended to the user as follows.

The determination unit 13 inputs the information indicating the CO2 emission amount for each movement timing (for example, the information of the movement start time and CO2ₜ in the table of FIG. 6) from the emission amount estimation unit 12. In addition, the determination unit 13 inputs the information related to the facility to be the recommended candidate from the emission amount estimation unit 12. The determination unit 13 determines the facility recommended to the user as follows, with reference to the input information.

First, the determination unit 13 specifies the highest CO2 emission amount among the CO2 emission amounts for each movement timing. For example, in the example illustrated in FIG. 6, the CO2 emission amount at the movement start time of 16:00 is specified as the highest CO2 emission amount. The determination unit 13 recommends the facility on the basis of the movement start time corresponding to the highest CO2 emission amount. For example, the determination unit 13 recommends the user to visit the facility in the case of starting the movement at the movement start time. Alternatively, the determination unit 13 recommends the facility to the user at the movement start time. Accordingly, it is possible to urge the user to avoid the movement at a timing when the CO2 emission amount is maximized. In addition, the determination unit 13 may perform a notification of urging the user to start the movement before the movement start time when the CO2 emission amount is maximized. In this case, the determination unit 13 may not recommend the facility that the user can visit.

The determination unit 13 computes a difference between the CO2 emission amount of each movement start time when a CO2 emission amount after the movement start time corresponding to the highest CO2 emission amount CO_{t_MAX} is estimated and the highest CO2 emission amount CO_{t_MAX}. FIG. 6 illustrates an example of the computed difference from CO_{t_MAX} for each movement start time described above. The computed difference is the CO2 emission amount that can be reduced by delaying the movement start time and is regarded as the credit. Here, a is a time difference between the movement start time corresponding to the highest CO2 emission amount CO_{t_MAX} and each movement start time, that is, a time for delaying the movement start time from the movement start time corresponding to the highest CO2 emission amount CO_{t_MAX}.

The determination unit 13 determines the facility recommended to the user for each delayed movement start time (for example, for each α=1H, 2H, 3H, . . . ). The determination unit 13 computes the sum of the movement time for visiting the facility and the average stay time for each facility to be the candidate recommended to the user. The determination unit 13 compares the time difference a related to each movement start time with the computed sum. As a result of the comparison, in a case where a difference between a and the sum described above is a threshold value or less, set in advance, the determination unit 13 further compares the CO2 emission amount that is the credit corresponding to a with the CO₂ emission amount when visiting the facility. In a case where the CO2 emission amount that is the credit corresponding to a is less than the CO2 emission amount when visiting the facility, the determination unit 13 sets the facility as the facility recommended to the user. That is, the determination unit 13 determines the peripheral facility that can be visited within the range of the credit as the facility recommended to the user.

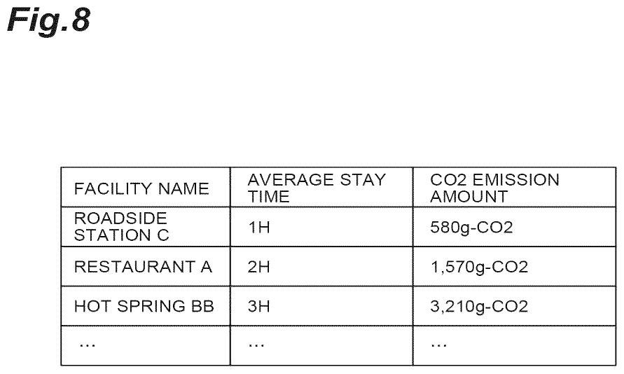

For example, in a case where the movement start time is 17:00 (α=1H), illustrated in FIG. 6, a difference from CO_{t_MAX} that is the credit is 1120 g-CO2. For a roadside station C, illustrated in FIG. 7, a difference between a and the sum of the movement time for visiting the facility and the average stay time is the threshold value or less. In addition, the CO2 emission amount when visiting the facility is 580 g-CO2 and is less than the difference of 1120 g-CO2 from CO_{t_MAX} that is the credit described above. Accordingly, for the movement start time of 17:00 (α=1H), the roadside station C is determined as the facility recommended to the user. Similarly, for each movement start time, the facility recommended to the user is determined. FIG. 8 illustrates an example of the facility determined to be recommended to the user.

The determination unit 13 recommends the facility determined to be recommended to the user to the user. For example, the determination unit 13 transmits a list of the facilities as illustrated in FIG. 8, and a guide for the stay time (for example, the average stay time) to the terminal 20 of the user. In addition, the determination unit 13 may include information indicating the movement start time corresponding to the highest CO2 emission amount CO_{t_MAX} to be a reference of recommendation, and the movement start time when visiting each facility, in recommendation information. In addition, as described above, the determination unit 13 may transmit the recommendation information to the terminal 20 at the movement start time corresponding to the highest CO2 emission amount CO_{t_MAX} (for example, in the example illustrated in FIG. 6, 16:00) to be the reference of recommendation.

The user to whom the facility is recommended is capable of substantially delaying the movement start time by visiting the facility during the movement using the automobile. As a result thereof, it is possible to reduce the CO2 emission amount.

Note that, the recommendation itself such as the transmission of the information to the terminal 20, based on the determination of the determination unit 13, may not be necessarily performed by the recommendation system 10, and may be performed by a system or a device other than the recommendation system 10.

In addition, a CO2 emission reduction amount computed as the credit may not be necessarily the difference from the maximum CO2 emission amount CO_{t_MAX} as described above. In addition, the movement start time to be the reference of recommendation may not be the movement start time corresponding to the maximum CO2 emission amount CO_{t_MAX}. For example, in a case where it is possible to reduce the CO2 emission amount by delaying the movement start time, a recommendation time desired by a provider performing the recommendation may be set as the movement start time to be the reference of recommendation, and the CO2 emission reduction amount computed as the credit may be set as a difference from the CO2 emission amount corresponding to the movement start time. For example, the CO2 emission amount when the movement start time is 16:00 is maximum, the CO2 emission amount when the movement start time is 17:00 is medium, the CO2 emission amount when the movement start time is 18:00 is small, and the CO2 emission amount when the movement start time is 17:00 is small, and in a case where the recommendation time desired by the provider is 17:00, the credit may be (CO2 Emission Amount When Movement Start Time Is 17:00)-(CO2 Emission Amount When Movement Start Time Is 17:00 or Later). The above is the function of the recommendation system 10 according to this embodiment.

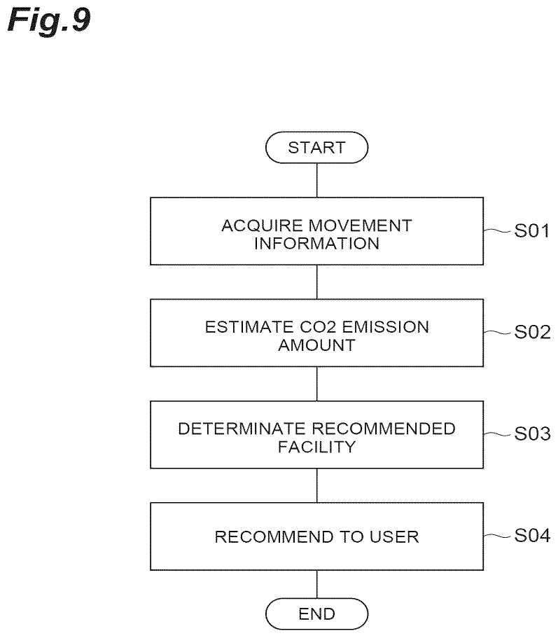

Subsequently, processing executed by the recommendation system 10 according to this embodiment (an operation method performed by the recommendation system 10) will be described using a flowchart in FIG. 9. First, the movement information indicating the departure point and the destination related to the future movement of the user using the automobile is acquired by the acquisition unit 11 (S01). Subsequently, for the movement related to the movement information, the CO2 emission amount due to the movement for each of the plurality of movement timings different from each other is estimated by the emission amount estimation unit 12 (S02). Subsequently, on the basis of the CO2 emission amount for each movement timing, the facility that the user can visit during the movement and that is recommended to the user is determined by the determination unit 13 (S03). Subsequently, the facility determined to be recommended to the user is recommended to the user by the determination unit 13 (S04). The above is the processing executed by the recommendation system 10 according to this embodiment.

In this embodiment, the CO2 emission amount due to the movement is estimated for each of the plurality of movement timings, and the facility that the user can visit during the movement and that is recommended to the user is determined on the basis of the estimated CO2 emission amount. By the user visiting the facility during the movement in accordance with the recommendation, it is possible to have the movement timing of the user coincide with the timing when the CO2 emission amount is low. Accordingly, according to this embodiment, it is possible to reduce the CO2 emission amount. In addition, according to this embodiment, it is possible to reduce the CO2 emission amount and improve the traveling speed by smoothing a traffic flow.

In addition, as with this embodiment, the CO2 emission amount may be estimated from the movement speed for each movement timing. According to such a configuration, it is possible to suitably and reliably estimate the CO2 emission amount. As a result thereof, it is possible to suitably and reliably reduce the CO2 emission amount. Here, the estimation of the CO2 emission amount may be performed for each movement timing, or may be performed without using the movement speed.

In addition, as with this embodiment, the difference between the highest CO2 emission amount among the plurality of movement timings and the CO2 emission amount at the other timing may be computed, and the recommended facility may be determined on the basis of the computed difference. According to such a configuration, it is possible to suitably and reliably determine the recommended facility, on the basis of the estimation result of the CO2 emission amount. As a result thereof, it is possible to suitably and reliably reduce the CO2 emission amount. Here, the determination of the recommended facility may not be necessarily performed as described above insofar as the CO2 emission amount for each movement timing is used.

In addition, as with this embodiment, the CO2 emission amount due to the movement when the user visits the facility to be the candidate recommended to the user during the movement may be estimated, and the facility recommended to the user may be determined also on the basis of the CO2 emission amount. According to such a configuration, it is possible to suitably and reliably determine the recommended facility, also on the basis of the CO2 emission amount due to the movement when the user visits the facility during the movement. As a result thereof, it is possible to suitably and reliably reduce the CO2 emission amount. Here, the CO2 emission amount due to the movement when the user visits the facility during the movement is not necessarily used for the determination of the recommended facility. For example, in a case where it is assumed that a movement not emitting CO2 is made when the user visits the facility, it is not necessary to use the CO2 emission amount described above.

In addition, as with this embodiment, the facility recommended to the user may be determined also on the basis of the assumed stay time in the facility to be the candidate recommended to the user. According to such a configuration, it is possible to determine a facility suitable to reduce the CO2 emission amount, as the facility recommended to the user. Note that, as the assumed stay time in the facility, any stay time other than the average stay time described above may be used. Here, the assumed stay time in the facility is not necessarily used for the determination of the recommended facility.

Note that, a block diagram used for the description of the above embodiment illustrates the blocks of function units. Such function blocks (configuration units) are attained by any combination of at least one of hardware and software. In addition, a method for attaining each of the function blocks is not particularly limited. That is, each of the function blocks may be attained by using one physically or logically coupled device, or may be attained by using a plurality of devices obtained by directly or indirectly (for example, in a wired or wireless manner) connecting two or more devices physically or logically separated from each other. The function block may be attained by combining software with the one device or the plurality of devices.

The function includes determining, judging, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, mapping (allocating), assigning, and the like, but is not limited thereto. For example, the function block (the configuration unit) performing the transmitting is referred to as a transmitting unit or a transmitter. In either case, as described above, a method for attaining the function block is not particularly limited.

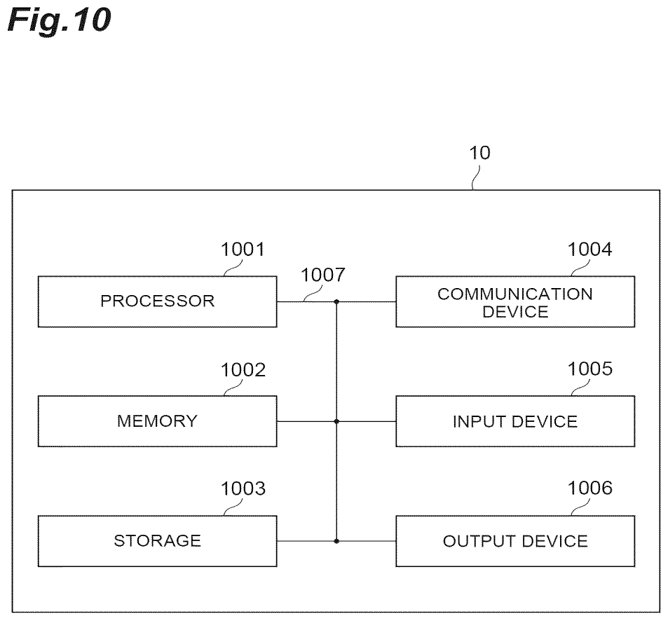

For example, the recommendation system 10 in one embodiment of the present disclosure may function as a computer performing information processing of the present disclosure. FIG. 10 is a diagram illustrating an example of a hardware configuration of the recommendation system 10 according to one embodiment of the present disclosure. The recommendation system 10 described above may be physically configured as a computer device including a processor 1001, a memory 1002, a storage 1003, a communication device 1004, an input device 1005, an output device 1006, a bus 1007, and the like. A hardware configuration of the terminal 20 may also be the same as described herein.

Note that, in the following description, the word “device” can be replaced with a circuit, a unit, or the like. The hardware configuration of the recommendation system 10 may be configured to include one or a plurality of devices illustrated in the drawings, or configured to exclude some devices.

Each of the functions in the recommendation system 10 is attained by reading predetermined software (program) on the hardware such as the processor 1001 and the memory 1002 such that the processor 1001 performs arithmetic, and controlling the communication of the communication device 1004 or controlling at least one of the reading and the writing of data in the memory 1002 and the storage 1003.

The processor 1001, for example, controls the entire computer by operating an operating system. The processor 1001 may be composed of a central processing unit (CPU) including an interface with a peripheral device, a control device, an arithmetic device, a register, and the like. For example, each of the functions in the recommendation system 10 described above may be attained by the processor 1001.

In addition, the processor 1001 reads out a program (a program code), a software module, data, and the like from at least one of the storage 1003 and the communication device 1004 to the memory 1002, and executes various pieces of processing in accordance with the program and the like. As the program, a program for causing a computer to execute at least a part of the operation described in the above embodiment is used. For example, each of the functions in the recommendation system 10 may be attained by a control program that is stored in the memory 1002 and operated in the processor 1001. It has been described that the various pieces of processing described above are executed by one processor 1001, but the various pieces of processing may be simultaneously or sequentially executed by two or more processors 1001. The processor 1001 may be implemented by one or more chips. Note that, the program may be transmitted from a network via an electric communication line.

The memory 1002 is a computer-readable recording medium, and for example, may be composed of at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), and the like. The memory 1002 may store a program (a program code), a software module, and the like that can be executed to carry out the information processing according to one embodiment of the present disclosure.

The storage 1003 is a computer-readable recording medium, and for example, may be composed of at least one of an optical disk such as a compact disc ROM (CD-ROM), a hard disk drive, a flexible disk, a magnetooptic disk (for example, a compact disk, a digital versatile disk, and a Blu-ray (Registered Trademark) disk), a smart card, a flash memory (for example, a card, a stick, and a key drive), a floppy (Registered Trademark) disk, a magnetic strip, and the like. The storage 1003 may be referred to as an auxiliary storage device. A storage medium provided in the recommendation system 10, for example, may be a database, a server, and other suitable media including at least one of the memory 1002 and the storage 1003. The communication device 1004 is hardware (a transmitting and receiving device) for performing communication with respect to a computer via at least one of a wired network and a wireless network, and for example, is also referred to as a network device, a network controller, a network card, a communication module, and the like.

The input device 1005 is an input device (for example, a keyboard, a mouse, a microphone, a switch, a button, a sensor, and the like) receiving input from the outside. The output device 1006 is an output device (for example, a display, a speaker, an LED lamp, and the like) carrying out output to the outside. Note that, the input device 1005 and the output device 1006 may have an integrated configuration (for example, a touch panel).

In addition, each of the devices such as the processor 1001 and the memory 1002 is connected by the bus 1007 for performing the communication of the information. The bus 1007 may be configured by using a single bus, or may be configured by using different buses for each of the devices.

In addition, the recommendation system 10 may be configured by including hardware such as a microprocessor, a digital signal processor (DSP), an application specific integrated circuit (ASIC), a programmable logic device (PLD), and a field programmable gate array (FPGA), and a part or all of each of the function blocks may be attained by the hardware. For example, the processor 1001 may be implemented by using at least one of the hardware.

The order of the processing procedure, the sequence, the flowchart, and the like of each of the aspects/embodiments described in the present disclosure may be changed unless there is contradiction. For example, in the method described in the present disclosure, the elements of various steps are presented by using an exemplary order, but the present disclosure is not limited to the presented specific order.

The input and output information or the like may be stored in a specific place (for example, a memory), or may be managed by using a management table. The input and output information or the like can be overwritten, updated, or edited. The output information or the like may be deleted. The input information or the like may be transmitted to other devices.

The judging may be performed by a value represented by 1 bit (0 or 1), may be performed by a truth value (Boolean: true or false), or may be performed by comparing numerical values (for example, comparing with a predetermined value).

Each of the aspects/embodiments described in the present disclosure may be used alone, may be used in combination, or may be used by being switched in accordance with the execution. In addition, the notifying of predetermined information (for example, the notifying of “X”) is not limited to being performed explicitly, but may be performed implicitly (for example, by not performing the notifying of the predetermined information).

The present disclosure has been described in detail, but it is obvious to a person skilled in the art that the present disclosure is not limited to the embodiment described in the present disclosure. The present disclosure can be carried out as modifications and variations without departing from the spirit and the scope of the present disclosure defined by the claims. Therefore, the description of the present disclosure is for illustrative purpose and is not intended to have any restrictive meaning on the present disclosure.

The software should be broadly construed to indicate an instruction, an instruction set, a code, a code segment, a program code, a program, a sub-program, a software module, an application, a software application, a software package, a routine, a sub-routine, an object, an executable file, an execution thread, a procedure, a function, and the like, regardless of being referred to as software, firmware, middleware, a microcode, and a hardware description language, or referred to as other names.

In addition, the software, the instruction, the information, and the like may be transmitted and received via a transmission medium. For example, in a case where the software is transmitted from a website, a server, or other remote sources by using at least one of a wired technology (a coaxial cable, an optical fiber cable, a twisted pair, a digital subscriber line (DSL), and the like) and a wireless technology (an infrared ray, a microwave, and the like), at least one of the wired technology and the wireless technology is included in the definition of the transmission medium.

The terms “system” and “network” used in the present disclosure are used interchangeably.

In addition, the information, the parameter, and the like described in the present disclosure may be represented by using an absolute value, may be represented by using a relative value from a predetermined value, or may be represented by using another corresponding information.

The term “determining” used in the present disclosure may include various operations. “Determining”, for example, may include considering judging, calculating, computing, processing, deriving, investigating, search, looking up, inquiry (for example, search in a table, a database, or another data structure), and ascertaining as “determining”. In addition, “determining” may include considering receiving (for example, receiving information), transmitting (for example, transmitting information), input, output, and accessing (for example, accessing data in a memory) as “determining”. In addition, “determining” may include considering resolving, selecting, choosing, establishing, comparing, and the like as “determining”. That is, “determining” may include “determining” any operation. In addition, “determining” may be replaced with “assuming”, “expecting”, “considering”, and the like.

The terms “connected” and “coupled”, or any variations thereof indicate any direct or indirect connection or coupling between two or more elements, and may include one or more intermediate elements between two elements “connected” or “coupled” to each other. The elements may be coupled or connected to each other physically, logically, or in combination thereof. For example, “connecting” may be replaced with “accessing”. In a case where the terms are used in the present disclosure, it can be considered that two elements are “connected” or “coupled” to each other by using at least one of one or more electric wires, cables, and printed electric connections, and as several non-determinative and non-inclusive examples, by using electromagnetic energy or the like having a wavelength in a wireless frequency region, a microwave region, and a light (both of visible and non-visible) region.

The expression “on the basis of” used in the present disclosure does not indicate “only on the basis of” unless explicitly stated otherwise. In other words, the expression “on the basis of” indicates both of “only on the basis of” and “at least on the basis of”.

Any reference to the elements using the addresses “first”, “second”, and the like used in the present disclosure does not generally limit the amount or the order of the elements. Such addresses can be used in the present disclosure as a convenient method for distinguishing two or more elements. Therefore, the reference to the first and second elements does not indicate that only two elements can be adopted or the first element necessarily precedes the second element in any way.

In the present disclosure, in a case where “include”, “including”, and variations thereof are used, such terms are intended to be inclusive as with the term “comprising”. Further, the term “or” used in the present disclosure is intended not to be exclusive OR.

In the present disclosure, for example, in a case where articles are added by translation, such as a, an, and the in English, the present disclosure may include that the nouns following such articles are in a plural form.

In the present disclosure, the term “A and B are different” may indicate that “A and B are different from each other”. Note that, the term may indicate that “each of A and B is different from C”. The terms “separated”, “coupled”, and the like may be construed as with “different”.

The recommendation system of the present disclosure has the following configurations.

[1] A recommendation system, including:
an acquisition unit configured to acquire movement information indicating a departure point and a destination related to a future movement of a user using a means of transportation emitting CO2;
an emission amount estimation unit configured to estimate, for a movement related to the movement information acquired by the acquisition unit, a CO2 emission amount due to the movement for each of a plurality of movement timings different from each other; and
a determination unit configured to determine a facility that the user can visit during the movement and that is recommended to the user, on the basis of the CO2 emission amount for each movement timing, estimated by the emission amount estimation unit.

[2] The recommendation system according to [1],
in which the emission amount estimation unit estimates the CO2 emission amount from a movement speed for each movement timing.

[3] The recommendation system according to [1] or [2],
in which the determination unit computes a difference between the highest CO2 emission amount among the plurality of movement timings and a CO2 emission amount at the other timing, and determines the facility that the user can visit during the movement and that is recommended to the user, on the basis of the computed difference.

[4] The recommendation system according to any one of [1] to [3],
in which the emission amount estimation unit estimates a CO2 emission amount due to a movement when the user visits a facility to be a candidate recommended to the user during the movement, and
the determination unit determines the facility that the user can visit during the movement and that is recommended to the user, also on the basis of the CO2 emission amount due to the movement when the user visits the facility during the movement, estimated by the emission amount estimation unit.

[5] The recommendation system according to any one of [1] to [4],
in which the determination unit determines the facility that the user can visit during the movement and that is recommended to the user, also on the basis of an assumed stay time in the facility to be the candidate recommended to the user.

### REFERENCE SIGNS LIST

10: recommendation system, 11: acquisition unit, 12: emission amount estimation unit, 13: determination unit, 20: terminal, 1001: processor, 1002: memory, 1003: storage, 1004: communication device, 1005: input device, 1006: output device, 1007: bus.

1. A recommendation system, comprising circuitry configured to:
acquire movement information indicating a departure point and a destination related to a future movement of a user using a means of transportation emitting CO2;
estimate, for a movement related to the acquired movement information, a CO2 emission amount due to the movement for each of a plurality of movement timings different from each other; and
determine a facility that the user can visit during the movement and that is recommended to the user, on the basis of the estimated CO2 emission amount for each movement timing.

2. The recommendation system according to claim 1,
wherein the circuitry estimates the CO2 emission amount from a movement speed for each movement timing.

3. The recommendation system according to claim 1,
wherein the circuitry computes a difference between the highest CO2 emission amount among the plurality of movement timings and a CO2 emission amount at the other timing, and determines the facility that the user can visit during the movement and that is recommended to the user, on the basis of the computed difference.

4. The recommendation system according to claim 1,
wherein the circuitry estimates a CO2 emission amount due to a movement when the user visits a facility to be a candidate recommended to the user during the movement, and
determines the facility that the user can visit during the movement and that is recommended to the user, also on the basis of the estimated CO2 emission amount due to the movement when the user visits the facility during the movement.

5. The recommendation system according to claim 1,
wherein the circuitry determines the facility that the user can visit during the movement and that is recommended to the user, also on the basis of an assumed stay time in a facility to be a candidate recommended to the user.
